(19) United States
(12) Patent Application Publication
(10) Pub. No.: US 2026/0168925 A1
(43) Pub. Date: Jun. 18, 2026

(54) Method and Apparatus for Measuring Polarization Scattering Model Parameters Based on Monte Carlo Approach

(71) Applicant: Beijing Institute of Technology, Beijing (CN)

(72) Inventors: Shaoli LIU, Beijing (CN); Yuan LIANG, Beijing (CN); Jianhua LIU, Beijing (CN); Huanxiong XIA, Beijing (CN); Jiachun HUANG, Beijing (CN)

(21) Appl. No.: 19/423,995

(22) Filed: Dec. 17, 2025

(30) Foreign Application Priority Data
Dec. 18, 2024 (CN) 202411871607.7

(51) Int. Cl. G01N 21/47

(52) U.S. Cl. CPC G01N 21/4738; G01N 2021/4792

(57) ABSTRACT

This disclosure provides a method and apparatus for measuring polarization scattering model parameters based on the Monte Carlo approach. The method includes: simulating a multiple scattering process of polarized light during diffuse reflection based on the Monte Carlo approach to obtain a first functional relationship between a depolarization coefficient of the polarized light and a scattering distance of the polarized light within a material; establishing a function curve between depolarization coefficients and scattering coefficients based on second functional relationships between the scattering coefficient and the scattering distance and the first functional relationships of different materials; fitting the function curve to a pre-constructed initial model to generate a polarization scattering model; and optimizing polarization parameters and intensity parameters in the polarization scattering model to obtain an optimized polarization scattering model.

### CROSS-REFERENCE TO RELATED APPLICATION

The present application claims priority to Chinese patent application No. 202411871607.7 filed in China on Dec. 18, 2024, a disclosure of which is incorporated in its entirety by reference herein.

### TECHNICAL FIELD

This disclosure relates to the technical field of polarized light, and in particular to a method and apparatus for measuring polarization scattering model parameters based on the Monte Carlo approach.

### BACKGROUND

The polarization reflection model, as a fundamental model describing the changes in intensity and polarization state of polarized light after reflection, combines the two dimensions of light to construct the interaction of light rays while adhering to physical principles. The concepts of specular reflection and diffuse reflection are equally applicable. However, the complete depolarization assumption followed by existing polarization reflection models when dealing with polarized diffuse reflection is not applicable when dealing with non-traditional highly scattering objects, and cannot accurately restore the polarization information of the object.

### SUMMARY

An embodiment of the present disclosure provides a method for measuring polarization scattering model parameters based on the Monte Carlo approach, including:
simulating a multiple scattering process of polarized light during diffuse reflection based on the Monte Carlo approach to obtain a first functional relationship between a depolarization coefficient of the polarized light and a scattering distance of the polarized light within a material;
establishing a function curve between depolarization coefficients and scattering coefficients based on second functional relationships between the scattering coefficient and the scattering distance and the first functional relationships of different materials;
fitting the function curve to a pre-constructed initial model to generate a polarization scattering model; and
optimizing polarization parameters and intensity parameters in the polarization scattering model to obtain an optimized polarization scattering model.

Optionally, the simulating the multiple scattering process of the polarized light during diffuse reflection based on the Monte Carlo approach to obtain the first functional relationship between the depolarization coefficient and the scattering distance of the polarized light within the material includes:
tracking the polarized light during the diffuse reflection using the meridional method in the Monte Carlo approach to obtain a multiple scattering matrix corresponding to the polarized light in the multiple scattering process; and
decomposing the multiple scattering matrix by using a polar decomposition method to obtain the first functional relationship between the depolarization coefficient and the scattering distance of the polarized light within the material.

Optionally, the optimizing the polarization parameters and the intensity parameters in the polarization scattering model to obtain the optimized polarization scattering model includes:
optimizing the polarization parameters in the polarization scattering model at pixel-level to obtain first optimized parameters;
optimizing the intensity parameters in the polarization scattering model based on the first optimized parameters to obtain second optimized parameters; and
performing error correction on Stokes vectors in the first optimized parameters and the second optimized parameters to obtain the optimized polarization scattering model.

Optionally, after the optimizing the polarization parameters in the polarization scattering model at pixel-level to obtain the first optimized parameters, the method further includes:
in a case that the first optimized parameters include a non-pixel-level parameter, converting the non-pixel-level parameter into a material-level parameter, and updating the first optimized parameters.

Optionally, the method further includes:
constructing the initial model based on first polarization and first intensity of the polarized light during diffuse reflection and second polarization and second intensity of the polarized light during specular reflection.

Optionally, the method further includes:
generating the first intensity based on the normalized diffusion principle and albedo; and
generating the first polarization based on the depolarization coefficient, the Fresnel reflection principle, and a rotation angle of the polarized light.

Optionally, the first functional relationship includes:
formula

$$λ = 0.836 {e}^{- 0.345 \frac{r}{{l}_{d}}} + 0.382 {e}^{- 69.237 \frac{r}{{l}_{d}}} ;$$

where λ is the depolarization coefficient, l_{d} is an average distance, and r is an actual scattering distance of the polarized light within the material;
the second functional relationship includes:
formula

$${l}_{d} = \frac{1}{{σ}_{tr}} = \frac{1}{{σ}_{t}^{′} \cdot \sqrt{3 ( 1 - {α}^{′} )}} , where , {α}^{′} = \frac{{σ}_{s}^{′}}{{σ}_{t}^{′}} , {σ}_{t}^{′} = {σ}_{s}^{′} + {σ}_{a} ,$$

σ's is the scattering coefficient, and σₐ is an absorption coefficient.

An embodiment of this disclosure further provides a network device, including: a processor, a memory, and a program stored in the memory and executable on the processor, wherein the program, when executed by the processor, implements the polarization scattering model parameter measurement method based on the Monte Carlo approach as described in any of the preceding embodiments.

An embodiment of this disclosure further provides a readable storage medium storing a program, wherein the program, when executed by a processor, implements the steps of the polarization scattering model parameter measurement method based on the Monte Carlo approach as described in any of the preceding embodiments.

### BRIEF DESCRIPTION OF THE DRAWINGS

FIG. 1 is a flowchart illustrating a polarization scattering model parameter measurement method based on the Monte Carlo approach according to an embodiment of the present disclosure;

FIG. 2 is a schematic diagram of the meridional plane of light rays when the mixed scattering phenomenon of polarized light is described based on the Monte Carlo approach according to an embodiment of the present disclosure;

FIG. 3 is a schematic diagram of a multiple scattering matrix according to an embodiment of the present disclosure;

FIG. 4 is a schematic diagram of a biaxial attenuation matrix after decomposition of the multiple scattering matrix according to an embodiment of the present disclosure;

FIG. 5 is a schematic diagram of a phase delay matrix after decomposition of the multiple scattering matrix according to an embodiment of the present disclosure;

FIG. 6 is a schematic diagram of a generalized depolarization matrix after decomposition of the multiple scattering matrix according to an embodiment of the present disclosure;

FIG. 7 is a schematic diagram showing the relationship between the depolarization coefficient and the scattering distance according to an embodiment of the present disclosure;

FIG. 8 is a schematic diagram showing the relationship between the depolarization coefficient and the scattering coefficient according to an embodiment of the present disclosure;

FIG. 9 is a flowchart of a process for optimizing parameters in the polarization scattering model according to an embodiment of the present disclosure;

FIG. 10 is a scatter plot showing the relationship between polarization degree and incident angle for a strongly specularly reflective material that is obtained through direct observation;

FIG. 11 is a scatter plot showing the relationship between polarization degree and incident angle resulting from simulating, in a rendering system, the strong specular reflection material in FIG. 10 by using the polarization scattering model according to this disclosure;

FIG. 12 is a scatter plot showing the relationship between polarization degree and incident angle for a diffuse reflection material that is obtained by direct observation;

FIG. 13 is a scatter plot showing the relationship between polarization degree and incident angle resulting from simulating, in a rendering system, the diffuse reflection material in FIG. 12 by using the polarization scattering model according to this disclosure;

FIG. 14 is a schematic diagram showing the results of fitting for various materials by using the polarization scattering model according to the embodiments of the present disclosure;

FIG. 15 is a structural diagram of a polarization scattering model parameter measurement apparatus based on the Monte Carlo approach according to an embodiment of the present disclosure.

### DETAILED DESCRIPTION

The technical solutions of the embodiments of the present disclosure will be clearly and completely described below with reference to the accompanying drawings. Obviously, the described embodiments are only some embodiments of the present disclosure, and not all embodiments. Based on the embodiments of the present disclosure, all other embodiments obtained by those skilled in the art without creative effort are within the scope of the present disclosure.

Existing polarimetric bidirectional reflection distribution function (pBRDF) models primarily focus on representing specular reflection component and diffuse reflection component. Some models extend their scope to scattering, covering singlet scattering, but only from the same exit point. While scattering is generally approximated by diffuse reflection component, when the scattering distance of the scattering phenomenon in the object being illuminated exceeds the observation distance, it is obvious that the scattering, namely, the subsurface scattering, cannot be ignored. Conventional technologies assume that the polarized light penetrating the object's surface and then exiting is completely depolarized. However, if scattering cannot be ignored, models built upon this assumption clearly contain errors.

Therefore, this disclosure believes that such scattered reflected light has a certain polarization preservation property, that is, polarized light has a depolarization coefficient, and during diffuse reflection, polarized light gradually reduces its polarization degree during scattering within the material based on the depolarization coefficient.

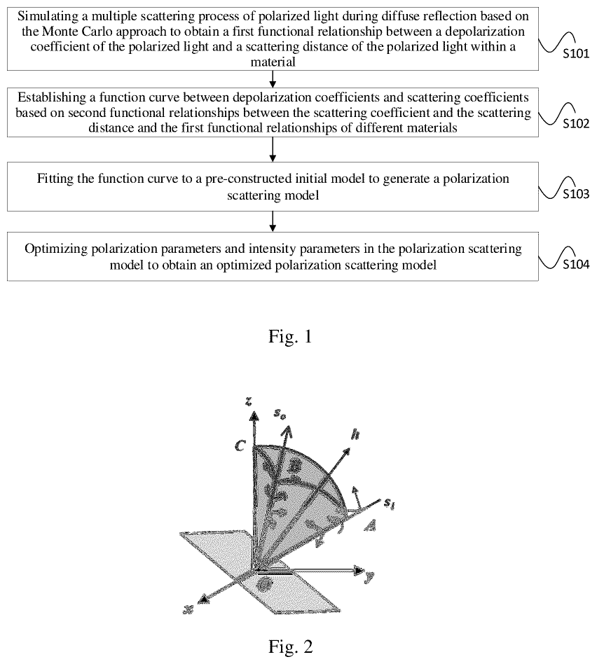

As shown in FIG. 1, an embodiment of the disclosure provides a method for measuring polarization scattering model parameters based on the Monte Carlo approach, which includes the following steps S101, S102, S103 and S104.

Step S101: Simulating a multiple scattering process of polarized light during diffuse reflection based on the Monte Carlo approach to obtain a first functional relationship between a depolarization coefficient of the polarized light and a scattering distance of the polarized light within a material.

Step S102: Establishing a function curve between depolarization coefficients and scattering coefficients based on second functional relationships between the scattering coefficient and the scattering distance and the first functional relationships of different materials.

Step S103: Fitting the function curve to a pre-constructed initial model to generate a polarization scattering model.

In step S103, the initial model is constructed based on the traditional pBRDF model, is classified into two parts: intensity and polarization according to the composition of the reflected light, and has the specific form as shown below:

$$P = {k}^{s} \hat{{M}^{s}} + {k}^{d} \hat{{M}^{d}}$$

where k^{s} is the intensity parameter corresponding to specular reflection, and k^{d} is the intensity parameter corresponding to diffuse reflection, the intensity parameters being used to reflect the change in intensity of light after reflection; [symbol] is the polarization parameter corresponding to specular reflection, and [symbol] is the polarization parameter corresponding to diffuse reflection, the polarization parameters being a normalized Mueller matrix, which reflects the change in polarization state of light after reflection.

Unlike existing technologies, [symbol] includes a multiple scattering matrix Mₘᵤₗₜᵢₚₗₑ, and Mₘᵤₗₜᵢₚₗₑ includes a depolarization coefficient λ.

Step S104: Optimizing polarization parameters and intensity parameters in the polarization scattering model to obtain an optimized polarization scattering model.

In embodiments of the disclosure, polarized light is assumed to have a depolarization coefficient. During diffuse reflection, the polarization degree of polarized light gradually decreases during scattering within the material based on the depolarization coefficient. First, the multiple scattering process of polarized light during diffuse reflection is simulated using the Monte Carlo approach to obtain a first functional relationship between the depolarization coefficient and the scattering distance of polarized light within the material. Then, based on second functional relationships between the scattering coefficient and the scattering distance of different materials, a function curve between the depolarization coefficients and the scattering coefficients is established. Next, the function curve is fitted to a pre-constructed initial model to generate a polarization scattering model. Finally, the polarization parameters and intensity parameters in the polarization scattering model are optimized to obtain an optimized polarization scattering model. The optimized polarization scattering model takes the depolarization coefficient into account, and thus can more accurately restore the polarization information of the object, and can handle non-traditional highly scattering objects.

Optionally, the simulating a multiple scattering process of the polarized light during diffuse reflection based on the Monte Carlo approach to obtain the first functional relationship between the depolarization coefficient and the scattering distance of the polarized light within the material includes:
tracking the polarized light during the diffuse reflection using the meridional method in the Monte Carlo approach to obtain a multiple scattering matrix corresponding to the polarized light in the multiple scattering process; and
decomposing the multiple scattering matrix by using a polar decomposition method to obtain the first functional relationship between the depolarization coefficient and the scattering distance of the polarized light within the material.

In embodiments of this disclosure, regarding polarization, the scattering of polarized light within a material leads to changes in polarization state and rotation of the coordinate system. Therefore, embodiments of the disclosure describe the mixed scattering phenomenon of polarized light based on the Monte Carlo approach. The scattering process of light within an object is simulated as a collision and reflection process between photons and particles within the material. Each collision and reflection are considered as a specular-reflection-like process. As shown in FIG. 2, sᵢ denotes the incident light, s₀ denotes the outgoing light, the Z-axis is the reference axis and remains unchanged throughout the simulation, AOB is the scattering plane, and AOC and BOC are the incident and outgoing meridional planes respectively, which change with each scattering. The incident and reflected rays of polarized light in the diffuse reflection process are tracked according to the meridional plane method in the Monte Carlo approach, to simulate the transmission of polarized light in the scattering medium, and the reference planes corresponding to the photon polarization state before and after each scattering are updated in a timely manner.

With reference to the process of specular reflection, a single scattering can be represented as:

$${M}_{single} = R ( - γ ) M ( θ ) θR ( β )$$

where, R(−γ) and R(β) are rotation matrices, and can be expressed as:

$${M}_{R} ( δ ) = [ \begin{matrix}1 & 0 & 0 & 0 \\ 0 & 1 & 0 & 0 \\ 0 & 0 & cos ( δ ) & - sin ( δ ) \\ 0 & 0 & sin ( δ ) & cos ( δ )\end{matrix} ]$$

when δ is −γ, M_{R}(δ) is the matrix expression for R(−γ), and when δ is β, M_{R}(δ) is the matrix expression for R(β).

M(θ) is the single scattering matrix, and, for a homogeneous spherical particle medium with isotropic properties, can be expressed as:

$$M ( θ ) = [ \begin{matrix}{s}_{11} ( α ) & {s}_{12} ( α ) & 0 & 0 \\ {s}_{12} ( α ) & {s}_{11} ( α ) & 0 & 0 \\ 0 & 0 & {s}_{33} ( α ) & {s}_{34} ( α ) \\ 0 & 0 & - {s}_{34} ( α ) & {s}_{33} ( α )\end{matrix} ]$$

where, α is the scattering angle AOB, and s₁₁, s₁₂, s₃₃, s₃₄ in the matrix can be obtained by solving the scattering amplitude of Mie scattering. It should be noted that s₁₁, s₁₂, s₃₃, s₃₄ are not the focus of this disclosure and can be simplified in the following sections, so it will not be elaborated here.

Therefore, the multiple scattering matrix of the multiple scattering process can be expressed as:

$${M}_{multiple} = {\prod }_{k = 0}^{p} {R}_{( - {γ}_{k} )} M ( {θ}_{k} ) R ( {β}_{k} ) .$$

Specifically, in the simulation, the light beam can be considered as being composed of a large number of photons. By simulating a multiple scattering process of these photons, the simulation results are determined based on the photon distribution received by the detector. Theoretically, when the light beams are not coherent, the Stokes vector corresponding to each photon has additivity. If enough data is collected, the average polarization of the polarized light can very closely approximate the actual scattering and detection process. The outgoing and incident light can be expressed as:

$${s}_{o} = {\sum }_{n = 1}^{m} {M}_{multiple}^{n} {s}_{i} .$$

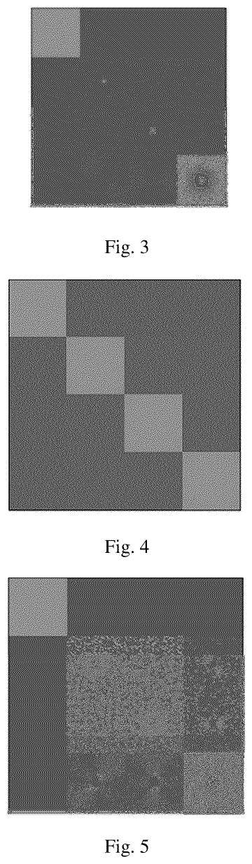

Furthermore, in the process of describing the mixed scattering phenomenon of polarized light based on the Monte Carlo approach, in order to eliminate interference factors such as particle scattering properties, particle size and density, it is stipulated that the light is incident perpendicularly, and the scattering object is a plane with zero curvature and has uniform internal medium parameters, the backscattered polarized light on the specified scattering plane is detected, and then the polarization state of the incident light is changed; as shown in FIG. 3, the multiple scattering matrix Mₘᵤₗₜᵢₚₗₑ is obtained by solving an overdetermined equation system.

After obtaining the multiple scattering matrix Mₘᵤₗₜᵢₚₗₑ, it is decomposed into a product form by using the Lu-Chipman method; it is assumed that the polarization effects occur in the following order: bidirectional attenuation M_{Δ}, phase delay M_{R}, and generalized depolarization M_{D}:

$${M}_{multiple} = {M}_{Δ} {M}_{R} {M}_{D}$$

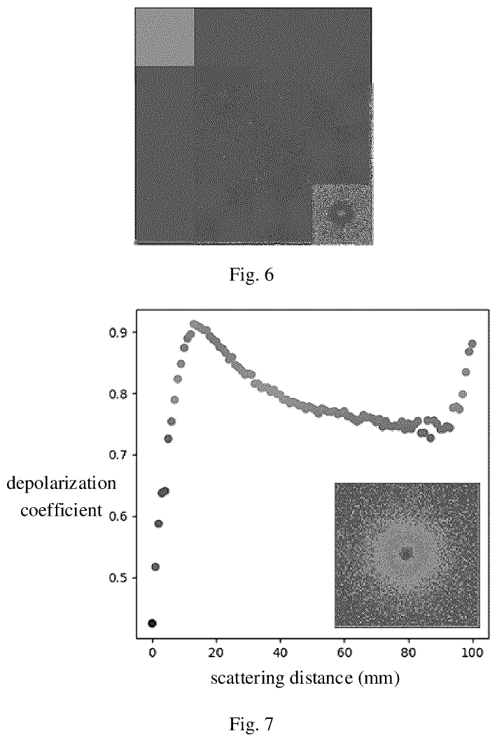

The decomposition results are as shown in FIGS. 4 to 6. The biaxial attenuation matrix M_{Δ} (FIG. 4) can be essentially considered an identity matrix, and the biaxial attenuation scalar is almost zero, which indicating that the multiple scattering process produces almost no biaxial attenuation effect. For the phase delay effect M_{R} (FIG. 5), phase delay was considered when calculating the Fresnel refraction term. For the depolarization matrix M_{D} (FIG. 6), through further observations, a diagram showing depolarization coefficients on the scattering plane is generated, as shown in FIG. 7. The depolarization coefficients also exhibit a diffuse distribution on the scattering plane, and the depolarization of the outgoing polarized light is strongly correlated with the outgoing distance. This is because each scattering event inside the object reduces the polarization of the polarized light. When a certain number of scattering events occur, i.e., a certain scattering distance is reached, the depolarization of the light reaches its maximum, and at this time, the outgoing light is closer to unpolarized light. However, the scattered light exiting before this point still possesses a certain polarization degree due to fewer scattering events. Therefore, embodiments of the disclosure hold that the depolarization property of the outgoing light should be related to the sampling distance. Based on this, the first two terms of the decomposed multiple scattering matrix can be ignored, retaining only the third term, i.e., the depolarization matrix, thus approximating the multiple scattering matrix Mₘᵤₗₜᵢₚₗₑ as follows:

$${M}_{multiple} = [ \begin{matrix}1 & 0 & 0 & 0 \\ 0 & 1 - λ & 0 & 0 \\ 0 & 0 & 1 - λ & 0 \\ 0 & 0 & 0 & 1 - λ\end{matrix} ]$$

where, λ is the depolarization coefficient.

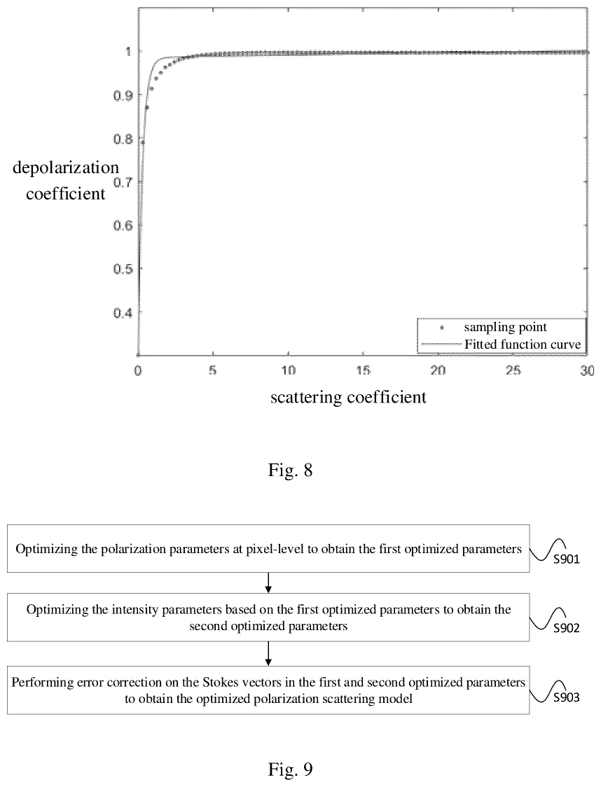

The average scattering distance l_{d} is introduced as a reference scale for distance sampling. Distance sampling is performed in the curve shown in FIG. 8 based on the average scattering distance l_{d}. Specifically, by using a Gaussian distribution as the sampling strategy, and using l_{d} to control the sampling range, the first functional relationship between the depolarization coefficient and the scattering distance of polarized light scattered within the material can be obtained:

$$λ = 0.836 {e}^{- 0.345 \frac{r}{{l}_{d}}} + 0.382 {e}^{- 69.237 \frac{r}{{l}_{d}}}$$

where λ is the depolarization coefficient, l_{d} is the average distance, and r is an actual scattering distance of the polarized light within the material.

Furthermore, in the step S102, the second functional relationships between the scattering coefficient and the average scattering distance of different materials are as follows:

$${l}_{d} = \frac{1}{{σ}_{tr}} = \frac{1}{{σ}_{t}^{′} \cdot \sqrt{3 ( 1 - {α}^{′} )}} where {α}^{′} = \frac{{σ}_{s}^{′}}{{σ}_{t}^{′}} , {σ}_{t}^{′} = {σ}_{s}^{′} + {σ}_{a} , {σ}_{s}^{′}$$

is the scattering coefficient, and σₐ is an absorption coefficient.

Based on the first and second functional relationships, the function curve between the scattering coefficients and depolarization coefficients of different materials can be obtained, as shown in FIG. 8, which can be expressed as:

$$λ = 0.984 {e}^{0.0005 {σ}_{s}^{′}} - 0.6416 {e}^{- 0.3 \; 409 {σ}_{s}^{′}} .$$

It should be noted that, the error of the function curve obtained according to the embodiments of the present disclosure relative to the actual sampling results is approximately 0.71%, and the root mean square error (RMSE) is 0.011, which is small, thus the method according to the embodiments of the present disclosure is highly accurate.

Optionally, the optimizing the polarization parameters and the intensity parameters in the polarization scattering model to obtain the optimized polarization scattering model includes:
optimizing the polarization parameters in the polarization scattering model at pixel-level to obtain first optimized parameters;
optimizing the intensity parameters in the polarization scattering model based on the first optimized parameters to obtain second optimized parameters;
performing error correction on Stokes vectors in the first optimized parameters and the second optimized parameters to obtain the optimized polarization scattering model.

In embodiments of the disclosure, polarization parameters include, but are not limited to aₚ,

$${σ}_{s}^{′}$$

and η, where aₚ is the unitized polarization coefficient, an optimized intermediate parameter defined in the embodiments of this disclosure, and represents the proportion of specular reflection to total reflection obtained from the polarization reflection model optimization;

$${σ}_{s}^{′}$$

is the material scattering coefficient, and is material specific; and η is the material refractive index, and is also material specific. Intensity parameters include, but are not limited to kₛ, σ and k_{d}, where kₛ is the specular albedo, and may be optimized to the pixel-level; σ is the material roughness; and k_{d} is the diffuse albedo, and may be optimized to the pixel-level. It should be noted that during the optimization process, the initial value for each parameter needs to be inputted into the model first to optimize the initial value.

As shown in FIG. 9, the process for optimizing the parameters of the polarization scattering model according to the embodiment of the disclosure includes the following steps S901, S902 and S903.

Step S901: Optimizing the polarization parameters aₚ,

$${σ}_{s}^{′}$$

and η at the pixel-level to obtain the first optimized parameters, i.e., the optimized parameters aₚ,

$${σ}_{s}^{′}$$

and η:

$${min}_{{a}_{p} , η , {μ}_{s}} {\frac{{λ}_{m}}{9} [ {\sum }_{i , j = 1}^{3} ( {\hat{M}}_{i , j}^{o b v} - {a}_{p} {\hat{M}}_{i , j}^{s} - {b}_{p} {\hat{M}}_{i , j}^{d} ) ]}^{2} + {{λ}_{ρ} ( {ρ}^{o b v} - ρ )}^{2}$$

$$where , {\hat{M}}_{i , j}^{o b v}$$

represents the observed Mueller matrix of the object,

$${\hat{M}}_{i , j}^{s}$$

represents the specular reflection Mueller matrix fitted by the model,

$${\hat{M}}_{i , j}^{d}$$

represents the diffuse reflection Mueller matrix fitted by the model; bₚ=1−aₚ, thus

$${a}_{p} {\hat{M}}_{i , j}^{s} + {b}_{p} {\hat{M}}_{i , j}^{d}$$

can be represented as the Mueller matrix of the object obtained thus by the model fitting; ρ^{obv} represents the magnitude of the observed linear polarization degree of the object, ρ represents the magnitude of the linear polarization degree fitted by the model, and λₘ and λ_{ρ} are the target function coefficient weights, which are set to 1 and 10, respectively, according to the fitting function results.

Step S902: Optimizing the intensity parameters kₛ, σ and k_{d} based on the first optimized parameters, especially aₚ (aₚ, as a normalized polarization coefficient, determines the reflected light during reflection) in the first optimized parameters, to obtain the second optimized parameters, i.e., the optimized parameters kₛ, σ and k:

$${min}_{{k}_{s} , σ} \frac{1}{K} {\sum }_{k = 1}^{K} {( {a}_{p} \cdot {s}_{0} - {k}^{s} \cdot {M}_{00}^{s} )}^{2}$$

$${min}_{{k}_{d}} \frac{1}{K} {\sum }_{k = 1}^{K} {[ ( 1 - {a}_{p} ) \cdot {s}_{0} - {k}^{d} \cdot {M}_{00}^{d} ]}^{2}$$

where, K is the number of effective pixels after masking, s₀ is the first dimension of the outgoing Stokes vector, namely, the magnitude of light intensity,

$${M}_{00}^{s}$$

is the first element of the Mueller matrix of specular reflection in the model before normalization, and

$${M}_{00}^{d}$$

is the first element of the Mueller matrix of diffuse reflection in the model before normalization.

Step S903: Performing error correction on the Stokes vectors of

$${σ}_{s}^{′} ,$$

η, kₛ, σ and k_{d} in the first and second optimized parameters to obtain the optimized polarization scattering model.

Optionally, after the optimizing the polarization parameters in the polarization scattering model at pixel-level to obtain the first optimized parameters, the method further includes:
in a case that the first optimized parameters include a non-pixel-level parameter, converting the non-pixel-level parameter into a material-level parameter, and updating the first optimized parameters.

In embodiments of this disclosure, after pixel-level optimization of the polarization parameters aₚ,

$${σ}_{s}^{′}$$

and η to obtain the first optimized parameters, since

$${σ}_{s}^{′}$$

and η are not pixel-level, the following optimization is performed after the first step to convert

$${σ}_{s}^{′}$$

and η into material-level parameters:

$${min}_{η , {μ}_{s}} \frac{1}{K} {\sum }_{k = 1}^{K} {( {ρ}_{k}^{obv} - {ρ}_{k} )}^{2}$$

where K is the number of effective pixels after masking, thus, material-level results can be obtained.

Optionally, the method further includes:
constructing the initial model based on first polarization and first intensity of the polarized light during diffuse reflection and second polarization and second intensity of the polarized light during specular reflection.

In embodiments of this disclosure, the initial model is constructed based on the traditional pBRDF model, is classified according to the composition of the reflected light into two parts: intensity and polarization, and has the specific form as shown below:

$$P = {k}^{s} + {k}^{d}$$

where, k^{s} is the intensity parameter corresponding to specular reflection (i.e., the second intensity), and k^{d} is the intensity parameter corresponding to diffuse reflection (i.e., the first intensity), the intensity parameters being used to reflect the intensity change of light after reflection; [symbol] is the polarization parameter corresponding to specular reflection (i.e., the second polarization), and [symbol] is the polarization parameter corresponding to diffuse reflection (i.e., the first polarization), the polarization parameters being a normalized Mueller matrix, to reflect the change in polarization state of light after reflection.

Unlike existing technologies, [symbol] includes a multiple scattering matrix Mₘᵤₗₜᵢₚₗₑ, and Mₘᵤₗₜᵢₚₗₑ includes a depolarization coefficient λ.

Specifically, the expressions of k^{s} and [symbol] corresponding to specular reflection is the same as those in the related art:

$${k}^{s} = {k}_{s} \frac{D ( {θ}_{h} ; {σ}_{s} ) G ( {θ}_{i} , {θ}_{o} ; {σ}_{s} )}{4 ( n \cdot {ω}_{i} ) ( n \cdot {ω}_{o} )}$$

where k^{s} is the specular albedo, D (θₕ; σₛ) is the normal distribution function, which describes the microscopic normal distribution of tiny mirrors, and G(θᵢ, θ₀; σₛ) is a geometric function, which describes the self-occlusion property of a micro-surface;

$${M}^{s} = {R}_{h \to 0} ( {φ}_{0} ) {F}^{R} ( {θ}_{h} ; η ) {R}_{i \to h} ( {φ}_{i} )$$

where, R_{i→h}(φᵢ) is the rotation Mueller matrix that rotates by φᵢ along the incident light axis from the initial incident plane, F^{R}(θₕ;η) is the Fresnel reflection matrix of the pure linear bidirectional attenuation effect of polarized light; R_{h→0} (φ₀) is the rotation Mueller matrix that rotates by φ₀ along the outgoing light axis from the plane where the specular reflection occurs.

Optionally, the method further includes:
generating the first intensity based on the normalized diffusion principle and albedo; and
generating the first polarization based on the depolarization coefficient, the Fresnel reflection principle, and a rotation angle of the polarized light.

In embodiments of this disclosure, the expressions of k^{d} and [symbol] corresponding to diffuse reflection differ from those in the related art. From the perspective of intensity, a normalized diffusion principle is introduced:

$${k}^{d} = {k}_{d} \cdot \frac{{e}^{- \frac{r}{d}} + {e}^{- \frac{r}{3 d}}}{8 π dr}$$

where k^{d} is the albedo of diffuse reflection, r is the sampled value of scattering distance, and d is a parameter that affects the shape of the curve.

From the perspective of polarization, the Mₘᵤₗₜᵢₚₗₑ matrix is introduced; the traditional diffuse reflection polarization component in existing technologies is expressed as follows:

$${M}^{d} = R ( {ϕ}_{0} ) {F}^{T} ( {θ}_{o} ; η ) {M}_{0} {F}^{T} ( {θ}_{i} ; η ) R ( {ϕ}_{i} )$$

where R(φ₀), R(φᵢ) are rotation Mueller matrices; F^{T}(θ₀; η), F^{T}(θᵢ;η) are transmission Fresnel matrices, which describe the Fresnel transmission effect produced when light penetrates the surface of an object, and have specific form as follows:

$${F}^{F ∈ \{ T , R \}} = [ \begin{matrix}\frac{{F}^{⊥} + {F}^{‖}}{2} & \frac{{F}^{⊥} - {F}^{‖}}{2} & 0 & 0 \\ \frac{{F}^{⊥} - {F}^{‖}}{2} & \frac{{F}^{⊥} + {F}^{‖}}{2} & 0 & 0 \\ 0 & 0 & \sqrt{{F}^{⊥} {F}^{‖}} cos δ & \sqrt{{F}^{⊥} {F}^{‖}} sin δ \\ 0 & 0 & - \sqrt{{F}^{⊥} {F}^{‖}} sin δ & \sqrt{{F}^{⊥} {F}^{‖}} cos δ\end{matrix} ]$$

where F represents the Fresnel transmission coefficient,

$${M}_{0} = [ \begin{matrix}1 & 0 & 0 & 0 \\ 0 & 0 & 0 & 0 \\ 0 & 0 & 0 & 0 \\ 0 & 0 & 0 & 0\end{matrix} ] ,$$

and follows the complete depolarization assumption.

In the embodiments of this disclosure, M₀ is replaced with Mₘᵤₗₜᵢₚₗₑ, where Mₘᵤₗₜᵢₚₗₑ is expressed as:

$${M}_{multiple} = [ \begin{matrix}1 & 0 & 0 & 0 \\ 0 & 1 - λ & 0 & 0 \\ 0 & 0 & 1 - λ & 0 \\ 0 & 0 & 0 & 1 - λ\end{matrix} ]$$

where, λ is the depolarization coefficient of the polarized light.

The specific implementations of this disclosure are described in detail below with reference to Example 1 and Example 2. It should be noted that the following examples are only used to illustrate the present disclosure and do not limit the present disclosure.

Example 1: A virtual simulation experiment was conducted using the polarization scattering model parameter measurement method based on the Monte Carlo approach provided by this disclosure.

The rendering system (Mitsuba) was selected as the rendering tool for the simulation experiment. Mitsuba allows the use of measured polarized material as the object material, which is derived from real data and possesses high accuracy and reliability. Furthermore, it should be noted that rendering systems generally do not include rendering datasets for non-traditional translucent media; therefore, conventional materials were selected for simulation in this example.

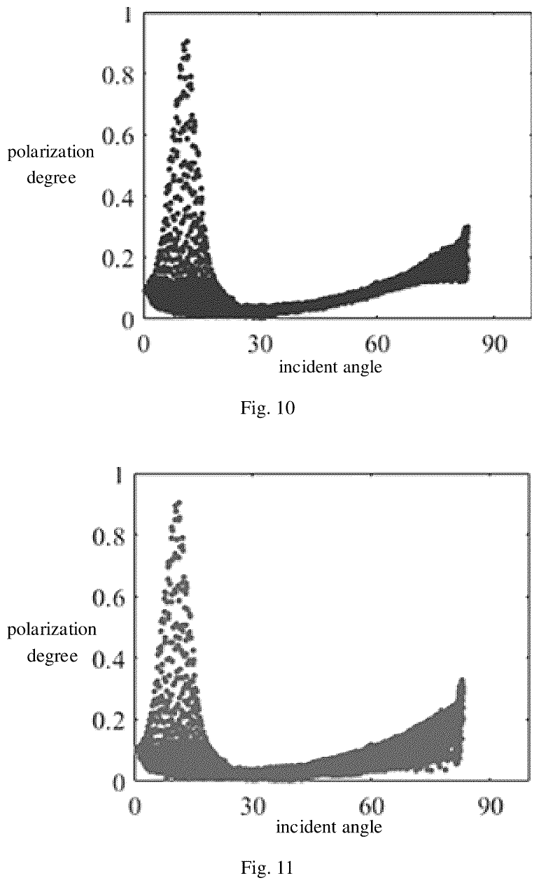

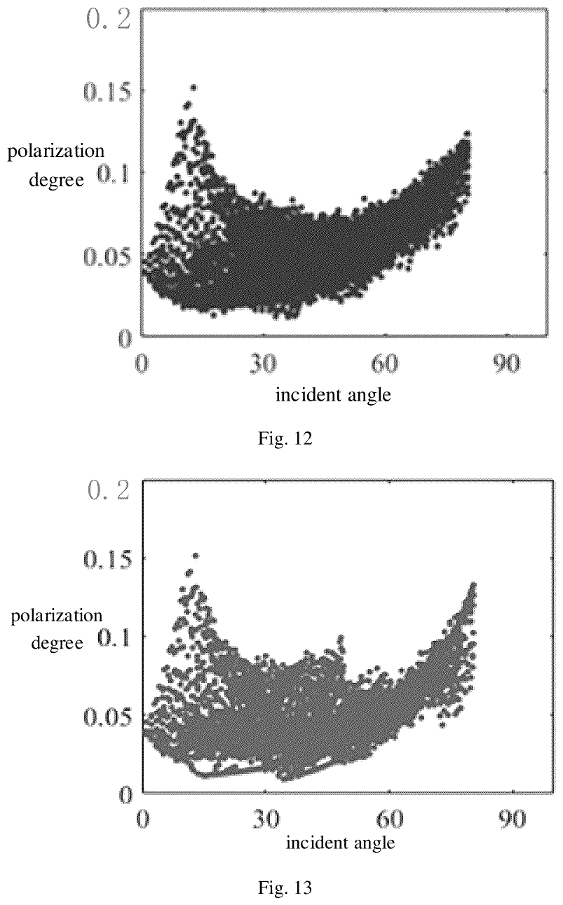

Experiments were conducted to fit the polarization degree and intensity of various traditional materials, including those with strong specular reflection and diffuse reflection, as shown in FIGS. 10 to 13. FIG. 10 is a scatter plot of the relationship between polarization degree and incident angle for the strongly specularly reflective material obtained through direct observation. FIG. 11 is a scatter plot of the relationship between polarization degree and incident angle for the strongly specularly reflective material in FIG. 10 resulting from simulation in the rendering system using the polarization scattering model provided by this disclosure. FIG. 12 is a scatter plot of the relationship between polarization degree and incident angle for the diffusely reflective material obtained through direct observation. FIG. 13 is a scatter plot of the relationship between polarization degree and incident angle for the diffusely reflective material in FIG. 12 resulting from simulation in the rendering system using the polarization scattering model provided by this disclosure. In this example, the relationship between polarization degree and incident angle is used to create a scatter plot to visually demonstrate the distribution of the polarization state of the object. This demonstrates that the polarization scattering model according to the embodiments of this disclosure has extremely high accuracy in fitting the polarization degree on objects made of traditional materials, regardless of whether the object has a higher proportion of specular reflection or diffuse reflection.

Example 2: A physical experiment was conducted using the polarization scattering model parameter measurement method based on the Monte Carlo approach provided by this disclosure:

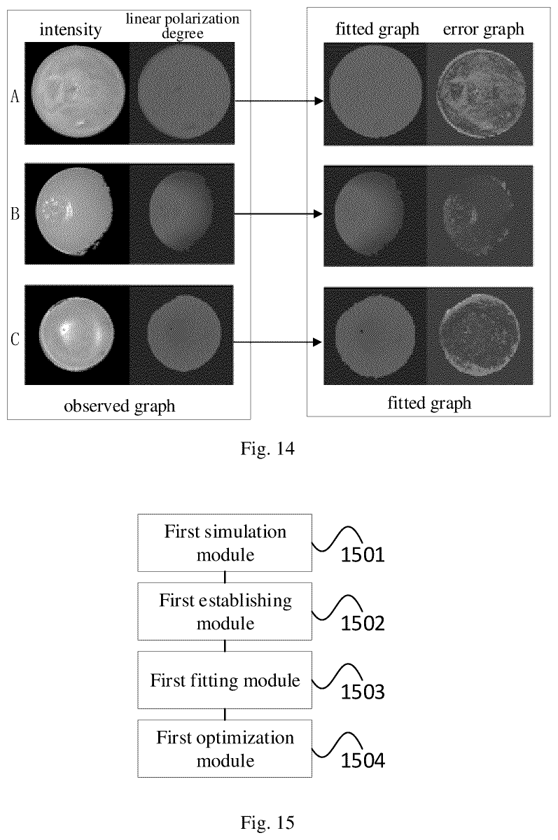

Highly scattering materials, especially highly scattering translucent materials, were selected as experimental subjects. The experimental results are as shown in FIG. 14. The polarization scattering model according to the embodiments of this disclosure was used to fit for three materials A, B, and C respectively, and the fitting results were compared with the observation results to obtain the error values. The transparency relationship of the three materials was C>B>A. Finally, the error value corresponding to material A was 0.0153, the error value corresponding to material B was 0.0185, and the error value corresponding to material C was 0.0081.

Specifically, in the physical experiment, A and B are of the same material, namely cured liquid silicone rubber, and C is made of translucent resin. According to the method proposed in this disclosure, the scattering coefficient of the test materials can be measured. The scattering coefficient σₛ′ of the cured liquid silicone rubber is 1.395 mm⁻¹, and the scattering coefficient of the translucent resin is 0.723 mm⁻¹. It can be concluded that the latter is more prone to scattering optical effect than the former. At the same time, based on the simulation experiment, the scattering coefficient of the first type (specular reflection) material, namely synthetic plastic, is 15.413 mm⁻¹, and the scattering coefficient of the second type (diffuse reflection) material, namely Teflon synthetic resin, is 14.449 mm⁻¹. Obviously, the scattering coefficients of opaque materials are much higher than those of translucent materials.

Therefore, it can be concluded that for highly scattering objects, their linear polarization degree is generally higher than those of traditional non-transparent objects, and the depolarization coefficients of translucent objects are lower than those of traditional non-translucent objects. Furthermore, the polarization scattering model according to the embodiments of this disclosure has a high fitting accuracy for the intensity and polarization degree of objects.

As shown in FIG. 15, an embodiment of this disclosure also provides a polarization scattering model parameter measurement apparatus based on the Monte Carlo approach, including:
a first simulation module 1501, configured to simulate the multiple scattering process of polarized light during diffuse reflection based on the Monte Carlo approach, to obtain a first functional relationship between a depolarization coefficient of the polarized light and a scattering distance of the polarized light within a material;
a first establishing module 1502, configured to establish a function curve between depolarization coefficients and scattering coefficients based on second functional relationships between the scattering coefficient and the scattering distance and the first functional relationships of different materials;
a first fitting module 1503, configured to fit the function curve to the pre-constructed initial model to generate a polarization scattering model; and
a first optimization module 1504, configured to optimize polarization parameters and intensity parameters in the polarization scattering model to obtain the optimized polarization scattering model.

Optionally, the first simulation module 1501 includes:
a first tracking unit, configured to track the polarized light in the diffuse reflection process based on the meridional method in the Monte Carlo approach to obtain the multiple scattering matrix corresponding to the polarized light in the multiple scattering process; and
a first decomposition unit, configured to decompose the multiple scattering matrix by using the polar decomposition method to obtain the first functional relationship between the depolarization coefficient and the scattering distance of the polarized light within the material.

Optionally, the first optimization module 1504 includes:
a first optimization unit, configured to optimize the polarization parameters in the polarization scattering model at pixel-level to obtain the first optimized parameters;
a second optimization unit, configured to optimize the intensity parameters in the polarization scattering model based on the first optimized parameters to obtain second optimized parameters; and
a third optimization unit, configured to perform error correction on Stokes vectors in the first optimized parameters and the second optimized parameters to obtain the optimized polarization scattering model.

Optionally, the first optimization module 1504 further includes:
a fourth optimization unit, configured to, in a case that the first optimized parameters include a non-pixel-level parameter, convert the non-pixel-level parameter into a material-level parameter, and update the first optimized parameters.

Optionally, the apparatus further includes:
a first constructing unit, configured to construct the initial model based on first polarization and first intensity of the polarized light during diffuse reflection and second polarization and second intensity of the polarized light during specular reflection.

Optionally, the first constructing unit includes:
a first generation unit, configured to generate the first intensity according to the normalized diffusion principle and albedo;
a second generation unit, configured to generate the first polarization based on the depolarization coefficient, the Fresnel reflection principle, and the rotation angle of the polarized light.

Optionally, the first functional relationship generated by the first simulation module 1501 includes:
formula

$$λ = 0.8 \; 36 {e}^{- 0.345 \frac{r}{{l}_{d}}} + 0.3 \; 82 {e}^{- 69.237 \frac{r}{{l}_{d}}} ;$$

where λ is the depolarization coefficient, l_{d} is an average distance, and r is an actual scattering distance of the polarized light within the material;
the second function relationship in the first establishing module 1502 includes:
formula

$${l}_{d} = \frac{1}{{σ}_{tr}} = \frac{1}{{σ}_{t}^{′} \cdot \sqrt{3 ( 1 - {α}^{′} )}} , where , {α}^{′} = \frac{{σ}_{s}^{′}}{{σ}_{t}^{′}} , {σ}_{t}^{′} = {σ}_{s}^{′} + {σ}_{a} , {σ}_{s}^{′}$$

is the scattering coefficient, and σₐ is an absorption coefficient.

It should be noted that, the apparatus embodiment is an apparatus corresponding to the above method embodiment. All implementations in the above method embodiment are applicable to the apparatus embodiment and can achieve the same technical effect.

An embodiment of this disclosure further provides a network device, including: a processor, a memory, and a program stored in the memory and executable on the processor. When the program is executed by the processor, the program implements the polarization scattering model parameter measurement method based on the Monte Carlo approach as described above, and achieves the same technical effect. To avoid repetition, it will not be described again here.

An embodiment of this disclosure further provides a readable storage medium storing a program, wherein the program, when executed by a processor, implements the steps of the polarization scattering model parameter measurement method based on the Monte Carlo approach as described above, and achieves the same technical effect; to avoid repetition, it will not be described again here. The computer-readable storage medium may be a read-only memory (ROM), a random access memory (RAM), a magnetic disk, or an optical disc, etc.

An embodiment of this disclosure further provides a computer program product including computer instructions. When the computer instructions are executed by a processor, they implement the steps of the polarization scattering model parameter measurement method based on the Monte Carlo approach as described above, and achieve the same technical effect. To avoid repetition, they will not be described again here.

It should be noted that, relational terms such as “first” and “second” used herein are used only to distinguish one entity or operation from another, and do not necessarily require or imply any such actual relationship or order between these entities or operations. Furthermore, the terms “including”, “comprising” or any other variations thereof are intended to cover non-exclusive inclusion, such that a process, method, article, or terminal apparatus that includes a list of elements includes not only those elements but also other elements not expressly listed, or elements inherent to such a process, method, article, or apparatus. Without further limitations, an element defined by the phrase “including one . . . ” does not exclude the presence of other identical elements in the process, method, article, or apparatus that includes said element.

Obviously, those skilled in the art can make various modifications and variations to this disclosure without departing from its spirit and scope. Therefore, if these modifications and variations fall within the scope of the claims of this disclosure and their equivalents, this disclosure also intends to include these modifications and variations.

What is claimed is:

1. A method for measuring polarization scattering model parameters based on a Monte Carlo approach, characterized by comprising:
simulating a multiple scattering process of polarized light during diffuse reflection based on the Monte Carlo approach to obtain a first functional relationship between a depolarization coefficient of the polarized light and a scattering distance of the polarized light within a material;
establishing a function curve between depolarization coefficients and scattering coefficients based on second functional relationships between the scattering coefficient and the scattering distance and the first functional relationships of different materials;
fitting the function curve to a pre-constructed initial model to generate a polarization scattering model; and
optimizing polarization parameters and intensity parameters in the polarization scattering model to obtain an optimized polarization scattering model.

2. The method for measuring polarization scattering model parameters based on the Monte Carlo approach according to claim 1, wherein the simulating the multiple scattering process of polarized light during diffuse reflection based on the Monte Carlo approach to obtain the first functional relationship between the depolarization coefficient of the polarized light and the scattering distance of the polarized light within the material comprises:
tracking the polarized light during the diffuse reflection using a meridional method in the Monte Carlo approach to obtain a multiple scattering matrix corresponding to the polarized light in the multiple scattering process; and
decomposing the multiple scattering matrix by using a polar decomposition method to obtain the first functional relationship between the depolarization coefficient and the scattering distance of the polarized light within the material.

3. The method for measuring polarization scattering model parameters based on the Monte Carlo approach according to claim 1, wherein the optimizing the polarization parameters and the intensity parameters in the polarization scattering model to obtain the optimized polarization scattering model comprises:
optimizing the polarization parameters in the polarization scattering model at pixel-level to obtain first optimized parameters;
optimizing the intensity parameters in the polarization scattering model based on the first optimized parameters to obtain second optimized parameters; and
performing error correction on Stokes vectors in the first optimized parameters and the second optimized parameters to obtain the optimized polarization scattering model.

4. The method for measuring polarization scattering model parameters based on the Monte Carlo approach according to claim 3, wherein, after the optimizing the polarization parameters in the polarization scattering model at pixel-level to obtain the first optimized parameters, the method further comprises:
in a case that the first optimized parameters comprise a non-pixel-level parameter, converting the non-pixel-level parameter into a material-level parameter, and updating the first optimized parameters.

5. The method for measuring polarization scattering model parameters based on the Monte Carlo approach according to claim 1, wherein the method further comprises:
constructing the initial model based on first polarization and first intensity of the polarized light during diffuse reflection and second polarization and second intensity of the polarized light during specular reflection.

6. The method for measuring polarization scattering model parameters based on the Monte Carlo approach according to claim 5, wherein the method further comprises:
generating the first intensity based on a normalized diffusion principle and albedo; and
generating the first polarization based on the depolarization coefficient, a Fresnel reflection principle, and a rotation angle of the polarized light.

7. The method for measuring polarization scattering model parameters based on the Monte Carlo approach according to claim 1, wherein the first functional relationship comprises:
formula
$$λ = 0. 8 \; 36 {e}^{- 0.345 \frac{r}{{l}_{d}}} + 0.3 \; 82 {e}^{- 69.237 \frac{r}{{l}_{d}}} ;$$
wherein λ is the depolarization coefficient, l_{d} is an average distance, and r is an actual scattering distance of the polarized light within the material;
the second functional relationship comprises:
formula
$${l}_{d} = \frac{1}{{σ}_{tr}} = \frac{1}{{σ}_{t}^{′} \cdot \sqrt{3 ( 1 - {α}^{′} )}} , wherein , {α}^{′} = \frac{{σ}_{s}^{′}}{{σ}_{t}^{′}} , {σ}_{t}^{′} = {σ}_{s}^{′} + {σ}_{a} , {σ}_{s}^{′}$$
is the scattering coefficient, and σₐ is an absorption coefficient.

8. A network device, comprising: a processor, a memory, and a program stored in the memory and executable on the processor, wherein the program, when executed by the processor, implements the following steps:
simulating a multiple scattering process of polarized light during diffuse reflection based on a Monte Carlo approach to obtain a first functional relationship between a depolarization coefficient of the polarized light and a scattering distance of the polarized light within a material;
establishing a function curve between depolarization coefficients and scattering coefficients based on second functional relationships between the scattering coefficient and the scattering distance and the first functional relationships of different materials;
fitting the function curve to a pre-constructed initial model to generate a polarization scattering model; and
optimizing polarization parameters and intensity parameters in the polarization scattering model to obtain an optimized polarization scattering model.

9. A non-transitory readable storage medium storing a program, wherein the program, when executed by a processor, implements the following steps:
simulating a multiple scattering process of polarized light during diffuse reflection based on a Monte Carlo approach to obtain a first functional relationship between a depolarization coefficient of the polarized light and a scattering distance of the polarized light within a material;
establishing a function curve between depolarization coefficients and scattering coefficients based on second functional relationships between the scattering coefficient and the scattering distance and the first functional relationships of different materials;
fitting the function curve to a pre-constructed initial model to generate a polarization scattering model; and
optimizing polarization parameters and intensity parameters in the polarization scattering model to obtain an optimized polarization scattering model.
